(19) United States
(12) Patent Application Publication
(10) Pub. No.: US 2019/0205264 A1
(43) Pub. Date: Jul. 4, 2019

(54) MEMORY MANAGEMENT UNIT PERFORMANCE THROUGH CACHE OPTIMIZATIONS FOR PARTIALLY LINEAR PAGE TABLES OF FRAGMENTED MEMORY

(71) Applicant: QUALCOMM INCORPORATED, SAN DIEGO, CA (US)

(72) Inventors: FELIX VARGHESE, Bangalore (IN); ZHENBIAO MA, Saratoga, CA (US); MARTIN JACOB, London (GB); KUMAR SAKET, Bangalore (IN); VASANTHA KUMAR BANDUR PUTTAPPA, Bangalore (IN); SUJEET KUMAR, Bangalore (IN)

(21) Appl. No.: 15/857,062

(22) Filed: Dec. 28, 2017

(51) Int. Cl. G06F 12/1081; G06F 12/1045; G06F 12/1027; G06F 12/1009; G06F 12/0895; G06F 12/0864

(52) U.S. Cl. CPC G06F 12/1081; G06F 12/1063; G06F 12/1027; G06F 12/1009; G06F 12/1054; G06F 12/0895; G06F 2212/6082; G06F 2212/65; G06F 2212/68; G06F 2212/304; G06F 2212/171; G06F 2212/1024; G06F 12/0864

(57) ABSTRACT

A MMU may read page descriptors (using virtual addresses as an index) in a burst mode from page tables in a system memory. The page descriptors may include intermediate physical addresses (“IPAs”, in stage 1) and corresponding physical addresses (“PAs”, in stage 2). The virtual address in conjunction with page table base address register is used to index page descriptors into main memory. The MMU may identify a first group of contiguous IPAs beginning at a base IPA and a second group of contiguous IPAs beginning at an offset from the base IPA. The first and second groups may be separated by at least one IPA not contiguous with either the first or second group. The MMU may read a first PA from the page tables that corresponds to the base IPA. The MMU may store an entry in a buffer that includes the PA and a first linearity tag.

### DESCRIPTION OF THE RELATED ART

Portable computing devices (“PCDs”) are becoming necessities for people on personal and professional levels. PCDs may include cellular telephones, portable digital assistants, portable game consoles, palmtop computers, and other portable electronic processing devices.

PCDs use memory management units (“MMUs”) to manage writing data to and reading data from one or more physical memory devices, such as random access memory devices. An MMU of a PCD may provide a virtual memory to the central processing unit (“CPU”) of the PCD that allows the CPU to run each application program in its own dedicated, contiguous virtual memory address space rather than having all of the application programs share the physical memory address space, which is often fragmented or non-contiguous. The purpose of such an MMU is to translate a virtual memory address (“VA”) into a physical memory address (“PA”) in response to a read or write transaction request from the CPU that identifies the VA. The CPU indirectly reads and writes PAs by directly reading and writing VAs to the MMU, which translates them into PAs and then writes or reads the PAs. Similarly, various systems of a PCD, such as a graphics processing unit (“GPU”), a multimedia client system, etc., may include their own system MMUs (“SMMUs”). An SMMU allows the system to operate in its own dedicated, contiguous virtual memory address space by translating VAs into PAs for that system.

In order to perform the translations, the MMU or SMMU accesses page tables, which may be stored in the PCD main memory. The page tables comprise page table entries. The page table entries are information that is used by the MMU or SMMU to map the VAs into PAs. The MMU or SMMU may include a translation lookaside buffer (“TLB”), which is a cache memory used to store recently used VA-to-PA mappings. When the MMU or SMMU needs to translate a VA into a PA, the MMU or SMMU first checks the TLB to determine whether there is a match for the VA. If the MMU or SMMU finds a match, it uses the mapping found in the TLB to determine the PA and then accesses the PA (i.e., reads or writes the PA). This is known as a TLB “hit.” If the MMU or SMMU does not find a match in the TLB, this is known as a TLB “miss.” In the event of a TLB miss, the MMU or SMMU performs a method known as a table walk. In a table walk, the MMU or SMMU identifies a page table corresponding to the VA and then reads one or more locations in the page table until the corresponding VA-to-PA mapping is found. The MMU or SMMU then uses the mapping to determine the corresponding PA, writes the mapping back to the TLB, and accesses the PA.

In a PCD or other processing device that implements operating system (“OS”) virtualization, a virtual memory monitor, also commonly referred to as a hypervisor, is interposed between the PCD hardware and the PCD system OS. The hypervisor executes in privileged mode and is capable of hosting one or more guest high-level OSs (“HLOSs”). In such systems, application programs running on the OSs use VAs of a first layer of virtual memory to address memory, and the OSs running on the hypervisor use intermediate physical addresses (“IPAs”) of a second layer of virtual memory to address memory. The MMU or SMMU performs a “Stage 1” translation to translate each VA into an IPA, and one or more “Stage 2” translations to translate each IPA into a PA.

In a Stage 1 translation, the MMU or SMMU may read the system memory in a burst mode. For example, an SMMU may read 16 page descriptors, each comprising a VA and corresponding IPA, in a single burst, and store them in its TLB. Such a burst-mode page descriptor read operation is also commonly referred to as a page descriptor pre-fetch operation. In a conventional Stage 2 translation, the SMMU does not operate in the burst mode except in an instance in which all (e.g., 16) of the IPAs from the Stage 1 translation are contiguous, i.e., increase linearly with respect to their corresponding VAs. Although it is generally desirable for IPAs in the system memory to be organized in a linearly increasing manner with respect to their corresponding VAs, operation of the PCD under real-world use cases inevitably leads to memory fragmentation. Under real-world use cases, the probability that the IPAs from a Stage 1 translation are discontiguous is very high. Therefore, the SMMU very frequently performs 16 individual read operations to read 16 IPAs, resulting in high translation latency.

### SUMMARY OF THE DISCLOSURE

Methods, systems, and computer program products are disclosed for storing address translations in a memory system.

An exemplary method for storing an address translation in a memory system may include reading, by an MMU in a burst mode, a plurality of page descriptors from one or more page tables in a system memory. The plurality of page descriptors may comprise a plurality of VAs and a plurality of IPAs. Each of the IPAs may uniquely correspond to one of the VAs. The exemplary method may further include identifying in the plurality of page descriptors, by the MMU, a first plurality of contiguous IPAs beginning at a first base IPA and a second plurality of contiguous IPAs beginning at an offset from the first base IPA. The first plurality of contiguous IPAs may be separated from the second plurality of contiguous IPAs by at least one IPA that is not contiguous with the first plurality of contiguous IPAs or the second plurality of contiguous IPAs. The exemplary method may still further include reading, by the MMU, all PAs from the one or more page tables in the system memory to detect a plurality and then the MMU decides to store only one only if both the IPA and PA are contiguous. The first PA may correspond to the first base IPA. The exemplary method may also include storing, by the MMU, an entry in a TLB comprising the first PA and a first linearity tag.

An exemplary system for storing an address translation in a memory system may include a system memory configured to store one or more page tables and an MMU having an MMU memory. The MMU may be configured to read a plurality of page descriptors in a burst mode from the one or more of the page tables in the system memory. The plurality of page descriptors may comprise a plurality of VAs and a plurality of IPAs. Each of the IPAs may uniquely correspond to one of the VAs. The MMU may further be configured to identify in the plurality of page descriptors a first plurality of contiguous IPAs beginning at a first base IPA and a second plurality of contiguous IPAs beginning at an offset from the first base IPA. The first plurality of contiguous IPAs may be separated from the second plurality of contiguous IPAs by at least one IPA that is not contiguous with the first plurality of contiguous IPAs or the second plurality of contiguous IPAs. The MMU may still further be configured to read all PAs from the one or more page tables in the system memory to detect a plurality and then the MMU decides to store only one only if both the IPA and PA are contiguous. The first PA may correspond to the first base IPA. The MMU may also be configured to store an entry in a TLB in the MMU memory comprising the first PA and a first linearity tag.

An exemplary system for storing an address translation in a memory system may include means for means for reading a plurality of page descriptors in a burst mode from one or more page tables in a system memory. The plurality of page descriptors may comprise a plurality of VAs and a plurality of IPAs. Each of the IPAs may uniquely correspond to one of the VAs. The exemplary system may further comprise means for identifying in the plurality of page descriptors a first plurality of contiguous IPAs beginning at a first base IPA and a second plurality of contiguous IPAs beginning at an offset from the first base IPA. The first plurality of contiguous IPAs may be separated from the second plurality of contiguous IPAs by at least one IPA that is not contiguous with the first plurality of contiguous IPAs or the second plurality of contiguous IPAs. The exemplary system may still further comprise means for reading all PAs from the one or more page tables in the system memory to detect a plurality and then decides to store only one only if both the IPA and PA are contiguous. The first PA may correspond to the first base IPA. The exemplary system may also comprise means for storing an entry in a TLB comprising the first PA and a first linearity tag.

An exemplary computer program product for storing an address translation in a memory system may comprise a computer-readable medium having stored thereon in executable form instructions, which, when executed by a memory management processor, may configure the memory management processor to read a plurality of page descriptors in a burst mode from one or more page tables in a system memory. The plurality of page descriptors may comprise a plurality of VAs and a plurality of IPAs. Each of the IPAs may uniquely correspond to one of the VAs. The instructions, when executed by the memory management processor, may further configure the memory management processor to identify in the plurality of page descriptors a first plurality of contiguous IPAs beginning at a first base IPA and a second plurality of contiguous IPAs beginning at an offset from the first base IPA. The first plurality of contiguous IPAs may be separated from the second plurality of contiguous IPAs by at least one IPA that is not contiguous with the first plurality of contiguous IPAs or the second plurality of contiguous IPAs. The instructions, when executed by the memory management processor, may still further configure the memory management processor to read all PAs from the one or more page tables in the system memory to detect a plurality and then the processor decides to store only one only if both the IPA and PA are contiguous. The first PA may correspond to the first base IPA. The instructions, when executed by the memory management processor, may also configure the memory management processor to store an entry in a TLB comprising the first PA and a first linearity tag.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a processing system, in accordance with exemplary embodiments.

FIG. 2 illustrates an example of a portion of an MMU memory into which page descriptors have been fetched in a first stage of a VA-to-PA translation, in accordance with exemplary embodiments.

FIG. 3 illustrates the portion of the MMU memory of FIG. 2 in relation to a first entry added to a fully associative TLB in a second stage of the VA-to-PA translation, in accordance with exemplary embodiments.

FIG. 4 is similar to FIG. 3, further illustrating a second entry added to the fully associative TLB.

FIG. 5 is similar to FIG. 4, further illustrating a third entry added to the fully associative TLB.

FIG. 6 is similar to FIG. 5, further illustrating a fourth entry added to the fully associative TLB.

FIG. 7 is similar to FIG. 3 but illustrating a way-based TLB.

FIG. 8 is similar to FIG. 7, further illustrating a second entry added to the way-based TLB.

FIG. 9 is similar to FIG. 8, further illustrating a third entry added to the way-based TLB.

FIG. 10 is similar to FIG. 9, further illustrating a fourth entry added to the way-based TLB.

FIG. 11 is a flow diagram illustrating a method for storing an address translation in a memory system, in accordance with exemplary embodiments.

FIG. 12 is a flow diagram illustrating another method for storing an address translation in a memory system, in accordance with exemplary embodiments.

FIG. 13 is a block diagram of a PCD, in accordance with exemplary embodiments.

### DETAILED DESCRIPTION

The word “exemplary” is used herein to mean “serving as an example, instance, or illustration.” Any aspect described herein as “exemplary” is not necessarily to be construed as preferred or advantageous over other aspects.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (“CDMA”) systems, time division multiple access (“TDMA”) systems, frequency division multiple access (“FDMA”) systems, orthogonal frequency division multiple access (“OFDMA”) systems, single-carrier frequency division multiple access (“SC-FDMA”) systems, and time division synchronous code division multiple access (“TD-SCDMA”) systems.

These multiple access technologies have been adopted in various telecommunication standards to provide a common protocol that enables different wireless devices to communicate on a municipal, national, regional, and even global level. An example telecommunication standard is Long Term Evolution (“LTE”). An example of an advancement to LTE technology is referred to as 5G. The term 5G represents an advancement of LTE technology including, for example, various advancements to the wireless interface, processing improvements, and the enablement of higher bandwidth to provide additional features and connectivity.

By way of example, a wireless multiple-access communication system may include a number of base stations (which in some examples may be referred to as eNodeBs or eNBs), each simultaneously supporting communication for multiple communication devices, otherwise known as user equipments (“UE”s). A base station may communicate with UEs on downlink channels (e.g., for transmissions from a base station to a UE) and uplink channels (e.g., for transmissions from a UE to a base station).

The term “portable computing device” (“PCD”) is used herein to describe any device operating on a limited capacity power supply, such as a battery. A PCD is an example of a UE. Although battery operated PCDs have been in use for decades, technological advances in rechargeable batteries coupled with the advent of third generation (“3G”) and fourth generation (“4G”) wireless technology have enabled numerous PCDs with multiple capabilities. Examples of PCDs include a cellular telephone, a satellite telephone, a pager, a personal digital assistant (“PDA”), a smartphone, a navigation device, a smartbook or reader, a media player, a combination of the aforementioned devices, or a laptop, tablet, or other hand-held computer with a wireless connection, among others.

The terms “component,” “system,” “subsystem,” “module,” “database,” and the like are used herein to refer to a computer-related entity, either hardware, firmware, or a combination of hardware and firmware. For example, a component may be, but is not limited to being, a processor of portion thereof, a processor or portion thereof as configured by a program, process, object, thread, executable, etc. A component may be localized on one system and/or distributed between two or more systems.

The terms “application” and “application program” may be used synonymously to refer to a software entity having executable content, such as object code, scripts, byte code, markup language files, patches, etc. In addition, an “application” may further include files that are not executable in nature, such as data files, configuration files, documents, etc.

The terms “central processing unit” (“CPU”), “digital signal processor” (“DSP”), and “graphics processing unit” (“GPU”) are non-limiting examples of processors that may reside in a PCD. These terms are used interchangeably herein except where otherwise indicated. A component, system, subsystem, module, etc., of the PCD may include and operate under the control of such a processor.

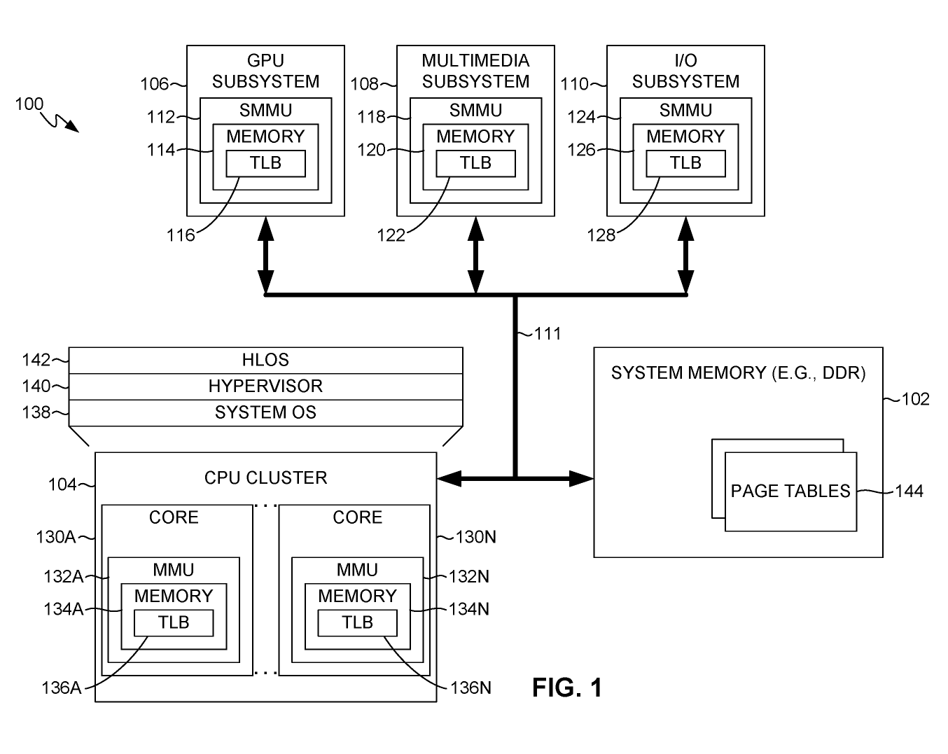

As illustrated in FIG. 1, in an illustrative or exemplary embodiment, a system 100 may include, among other elements, a system memory 102 and one or more subsystems, such as, for example, a CPU cluster (i.e., multi-core CPU) 104, a GPU subsystem 106, a multimedia subsystem 108, and an input/output subsystem 110. System 100 may be an example of a memory system in which the various systems or subsystems of system 100 perform memory transactions on system memory 102 or other memory. System memory 102 may comprise, for example, double data rate dynamic random access memory (“DDR-DRAM” or “DDR”). A system bus or similar data signal interconnect subsystem 111 may interconnect system memory 102, CPU cluster 104, GPU subsystem 106, multimedia subsystem 108, input/output subsystem 110 and other subsystems (not shown for purposes of clarity). A memory controller interfacing system memory 102 with interconnect subsystem 111 may be among such other subsystems or components included in system 100 that are not shown in FIG. 1 for purposes of clarity.

The GPU subsystem 106 may include, among other elements (not shown for purposes of clarity), a system memory management unit (“SMMU”) 112. The SMMU 112 may include a memory 114. The memory 114 may be configured to store a translation lookaside buffer (“TLB”) 116. Similarly, the multimedia subsystem 108 may include, among other elements (not shown for purposes of clarity), an SMMU 118. The SMMU 118 may include a memory 120. The memory 120 may be configured to store a TLB 122. Likewise, the input/output subsystem 110 may include, among other elements (not shown for purposes of clarity), an SMMU 124. The SMMU 124 may include a memory 126. The memory 126 may be configured to store a TLB 128. Each of SMMUs 112, 118, and 124 may be configured to operate in a virtual address space and to translate virtual addresses (“VAs”) in its address space into physical addresses (“PAs”) in system memory 102.

The CPU cluster 104 may include two or more CPU cores 130A through 130N, each of which may include a corresponding MMU 132A-132N. Each of MMUs 132-A-132N may be configured to operate in a virtual address space and to translate VAs in its address space into PAs in system memory 102. Each of MMUs 132A-132N may include a corresponding memory 134A-134N. Each of memories 134-134N may be configured to store a corresponding TLB 136A-136N. The CPU cluster 104 may operate under control of an operating system (“OS”) 138 and a hypervisor 140. The hypervisor 140 manages the VA-to-PA address translation for the CPU cluster 104. The hypervisor 140 may also manage a guest high-level OS (“HLOS”) 142.

The MMUs 132A-132N and the SMMUs 112, 118, and 124 are configured to translate VAs into PAs. As the SMMUs 112, 118, and 124 and the MMUs 132A-132N are all similarly configured to perform VA-to-PA address translations, except where otherwise indicated in this disclosure the term “MMU” also includes “SMMU” within its scope of meaning. In the following descriptions and examples, the term “MMU” thus refers to any of the SMMUs 112, 118, and 124 and the MMUs 132A-132N, except where otherwise indicated.

When a subsystem performs a memory transaction to write data to or read data from system memory 102, the subsystem's MMU first determines if the address translation or mapping is cached in its TLB (i.e., a TLB “hit”). If there is a TLB hit, the MMU may uses the mapping found in its TLB. However, if the MMU determines that the mapping is not cached in its TLB (i.e., a TLB “miss”), then the MMU may perform a two-stage table walk to determine the mapping, using information obtained from page tables 144 stored in system memory 102. The following examples illustrate various aspects of storing and otherwise providing such address translations or mappings.

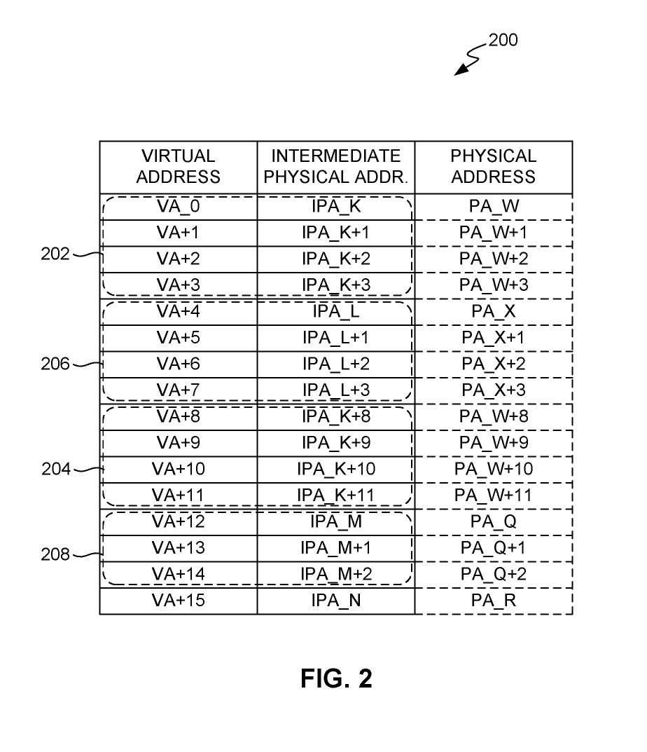

A first example is illustrated in FIGS. 2-6. With reference initially to FIG. 2, a first stage of a two-stage table walk may include an MMU reading 16 page descriptors from page tables 144 (FIG. 1), and storing the 16 page descriptors in the MMU's memory (e.g., in a data structure 200). The MMU may perform such an operation in a burst mode, in which all 16 page descriptors are read in response to the MMU initiating one burst-mode read operation beginning at a first or base VA. As understood by one of ordinary skill in the art, a burst mode greater than 16 page descriptors may be possible in the future. Such larger burst modes are included within the scope of this disclosure.

Each page descriptor comprises a VA and a corresponding intermediate physical address (“IPA”). In the example illustrated in FIG. 2, the 16 VAs are contiguous, in a range beginning at a first or base VA, VA_0. The term “contiguous” with respect to VAs means that each VA represents a location in a virtual memory space immediately adjacent to another location in the virtual memory space, and the VAs increase linearly from VA_0. Thus, the next VA following VA_0 may be referred to as VA+1 to indicate it is offset from VA_0 by one address location, etc., through the 16^{th} VA, which may be referred to as VA+15 to indicate it is offset from VA_0 by 15 address locations. In the illustrated example, each VA, IPA, and PA may represent 4 kilobytes (“kB”) of address space.

In FIG. 2 the first stage of the two-stage table walk is conceptualized in the form of three columns: VA, IPA, and PA. The PA column is shown in broken line to indicate that the PAs corresponding to the IPAs and VAs have not yet been determined at this stage. Indeed, the method described below may obviate storing all of the corresponding PAs, thereby economizing memory space. All of the PAs corresponding to the VAs need not be computed in the second stage of a table walk. Rather, as described below, in some instances only a base PA may be determined and stored in the second stage of the table walk; other PAs may be computed using the base PA the next time the MMU looks up the mapping in its TLB.

In other instances, if a set of IPAs are contiguous, all corresponding PAs are usually fetched in a burst mode during a second stage of a table walk. The set of PAs which are thereby fetched are checked whether they are contiguous and having the same attributes. Depending on outcome of this check, multiple PAs may get compressed into a single TLB entry or stored as multiple entries.

In the examples described in this disclosure, at least some, but not necessarily all, of the IPAs are contiguous. The term “contiguous” with respect to IPAs in a group means that each IPA in the group represents a location in an intermediate physical memory space immediately adjacent to another location in the intermediate physical memory space, and the IPAs increase linearly from a base IPA of the group in relation to the corresponding VAs. In the example illustrated in FIG. 2, a plurality of contiguous IPAs defining a first group 202 begins at a first base IPA, IPA_K. In the first group 202 the next IPA following IPA_K may be referred to as IPA_K+1 to indicate it is offset from IPA_K by one address location, etc., through a fourth IPA, which may be referred to as IPA_K+3 to indicate it is offset from IPA_K by three address locations. In the example illustrated in FIG. 2, the first group 202 includes only those four contiguous IPAs because IPA_L, which is immediately adjacent to IPA_K+3, does not represent a continuation of the linear increase in address location in relation to the corresponding VAs that characterizes the address space from IPA_K to IPA_K+3.

In the example illustrated in FIG. 2 there is a second group 204 defined by another plurality of contiguous IPAs that are offset from IPA_K. The second group 204 begins at IPA_K+8 (i.e., an offset of eight address locations from IPA_K) and continues through IPA_K+11. Note that in this example the IPAs of the second group 204 represent a continuation of the linear increase in address location in relation to the corresponding VAs that characterizes the address space from IPA_K to IPA_K+3.

In the example illustrated in FIG. 2 the plurality of contiguous IPAs beginning at a second base IPA, IPA_L, defines a third group 206. In the third group 206 the next IPA following IPA_L may be referred to as IPA_L+1 to indicate it is offset from IPA_L by one address location, etc., through a fourth IPA, which may be referred to as IPA_L+3 to indicate it is offset from IPA_L by three address locations. The third group 206 includes only those four contiguous IPAs because IPA_K+8, which is immediately adjacent to IPA_L+3, does not represent a continuation of the linear increase in address location in relation to the corresponding VAs that characterizes the address space from IPA_L to IPA_L+3. Note that the third group 206 separates the first and second groups 202 and 204, and the IPAs of the third group 206 are not contiguous with the IPAs of either of the first or second groups 202 and 204. The third group 206 represents a break in the linear increase in address location that characterizes the first and second groups 202 and 204.

In the example illustrated in FIG. 2 the plurality of contiguous IPAs beginning at a third base IPA, IPA_M, defines a fourth group 208. In the third group 208 the next IPA following IPA_M may be referred to as IPA_M+1 to indicate it is offset from IPA_M by one address location, etc., through a third IPA, which may be referred to as IPA_M+2 to indicate it is offset from IPA_M by two address locations. The fourth group 208 includes only those four contiguous IPAs because IPA_N, which is immediately adjacent to IPA_M+2, does not represent a continuation of the linear increase in address location in relation to the corresponding VAs that characterizes the address space from IPA_M to IPA_M+2.

In the example illustrated in FIG. 2, IPA_N is not contiguous with any other IPA and is therefore not part of any group. Although not illustrated in this example, it should be understood that in other examples there may be more than one such non-contiguous IPA.

In a second stage of the two-stage VA-to-PA translation an MMU may translate one or more IPAs into corresponding PAs, using information obtained from the page tables 144 (FIG. 1) to perform a table walk. As the manner in which an MMU may perform a table walk is well understood by one of ordinary skill in the art, the table walk is not described in this disclosure. In particular, one of ordinary skill in the art understands the manner in which an MMU may translate a single IPA into a corresponding PA.

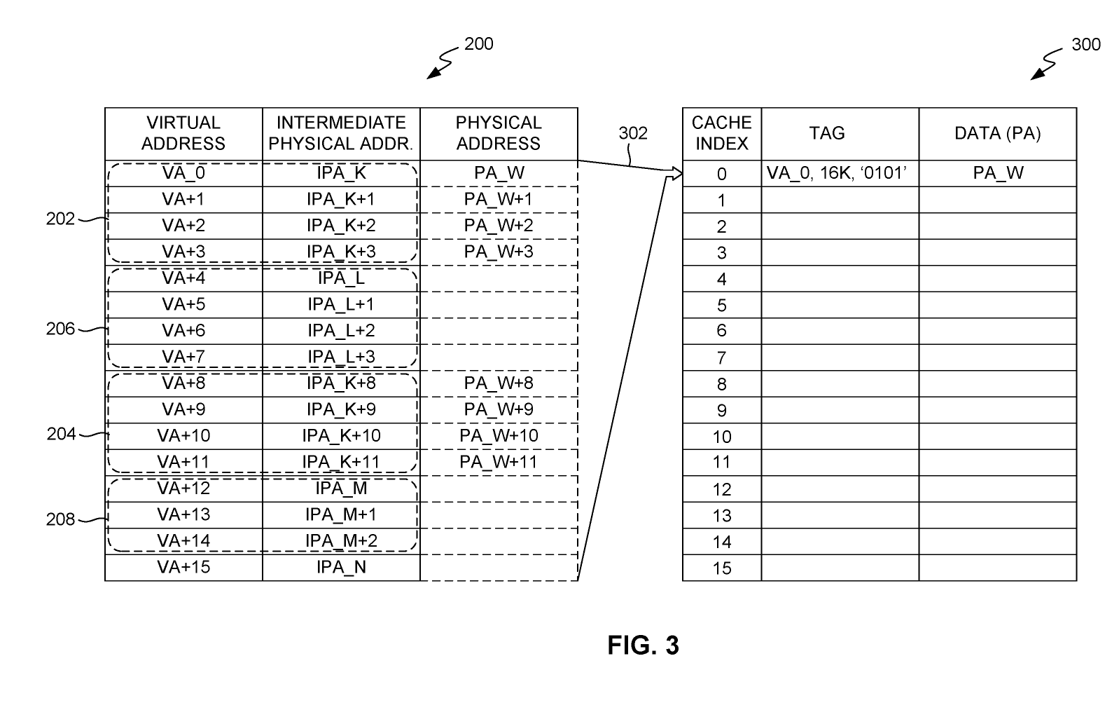

Continuing the example with reference to FIG. 3, in the second stage of the two-stage table walk the MMU may identify one or more groups, each defined by two or more contiguous IPAs. Having identified such a group, the MMU may then store information identifying the corresponding PAs in a compressed form. Significantly, in the example illustrated in FIG. 3, the MMU may store information identifying the PAs corresponding to the first and second groups 202 and 204 together in a compressed form, even though the first and second groups 202 and 204 are separated by the third group 206, because the first and second groups 202 and 204 are based on the same base IPA, IPA_K, and the first and second groups 202 and 204 together represent a linear increase in address location in relation to the corresponding VAs. That is, the linear increase in address location in relation to VA_0 through VA+3 that characterizes the address space from IPA_K to IPA_K+3 continues with the linear increase in address location in relation to VA+8 through VA+11 that characterizes the address space from IPA_K+8 to IPA_K+11.

As further illustrated in FIG. 3, the MMU may store information identifying the PAs corresponding to the first and second groups 202 and 204 together in a compressed form by storing a data structure 300 in its TLB containing only the base PA corresponding to IPA_K (i.e., the base IPA of groups 202 and 204) and a tag. In the example illustrated in FIG. 3, the base PA corresponding to the first and second groups 202 and 204 is PA_W. The MMU can determine PA_W using IPA_K in a conventional manner, as understood by one of ordinary skill in the art, using information obtained from the page tables 144 (FIG. 1). The MMU may need to do a burst mode fetch to read set of PA's, PA_W, PA_W+1 before determining a compression of PA's and thereby storing only PA_W is feasible.

The MMU need not individually store the remaining PAs corresponding to the IPAs of groups 202 and 204 because the tag enables those remaining PAs to be computed at a later time (e.g., contemporaneously with a memory transaction) from the stored base PA. The remaining PAs can be computed readily from the stored base PA because the remaining PAs increase linearly with respect to the base PA. In the example illustrated in FIG. 3: IPA_K corresponds to PA_W; IPA_K+1 corresponds to PA_W+1; IPA_K+2 corresponds to PA_W+2; and IPA_K+3 corresponds to PA_W+3. Thus, the remaining PAs corresponding to the first and second groups 202 and 204 can be computed by incrementing or otherwise adding an integer offset to PA_W. The tag indicates this integer offset in the following manner.

In the example illustrated in FIG. 3, a first entry (e.g., cache index “0”) in the above-referenced data structure 300 of the MMU's TLB thus may include PA_W and an associated tag. The tag includes the base VA of groups 202 and 204, a size parameter indicating the size of a burst-readable block 302 of IPAs that encompasses groups 202 and 204, and location information identifying locations of the contiguous IPAs (defining groups 202 and 204) within that block. In the illustrated example, the size parameter is 16 kB. The size of the block 302 of IPAs encompassing groups 202 and 204 may be 64 kB. However, other sizes besides 64 kB, such as sizes which are greater than 64 kB are possible and are understood by one of ordinary skill in the art.

For the present example, as each IPA (and VA) represents a 4 kB page, a size parameter of 16 kB indicates that the one or more contiguous IPAs can be found within a 64 kB region beginning at the base VA of groups 202 and 204. As understood by one of ordinary skill in the art, the size parameter may indicate page size as represented by each “1” in a linearity tag. In this case, groups 202 and 204 total about 16 kB each, where the linearity tag 0101 is stored with block 302 and is interpreted as “0 1[16 kB of 204] 0 1[16 kB of 202].” Note in FIG. 3 that a 64 kB region beginning at the base VA of groups 202 and 204 begins at VA_0 and ends at VA+15.

The location information may have a format that indicates the locations of the contiguous IPA groups within the block 302. In the example illustrated in FIG. 3, the location information is a 4-bit binary number in which each bit position corresponds to one of four contiguous 16 kB regions. The least-significant bit or zero-th position bit may correspond to the 16 kB region of VA_0 through VA+3, the next-most significant or first-position bit may correspond to the 16 kB region of VA+4 through VA+7, the second-position bit may correspond to the 16 kB region of VA+8 through VA+11, and the most-significant bit or third-position bit may correspond to the 16 kB region of VA+12 through VA+15. In the example illustrated in FIG. 3, a bit value of ‘1’ in a bit position of the 4-bit location information may indicate that the 16 kB region corresponding to that bit position is included in the contiguous IPAs of the block 302, while a bit value of ‘0’ in a bit position of the 4-bit binary location information may indicate that the 16 kB region corresponding to that bit position is not included in the contiguous IPAs of the block 302. Accordingly, in the example illustrated in FIG. 3 the location information of ‘0101’ indicates that: the region of VA_0 through VA+3 is included in the contiguous IPAs of the block 302 (which in this example consists of group 202); the region of VA+4 through VA+7 is not included in the contiguous IPAs of the block 302; the region of VA+8 through VA+11 is included in the contiguous IPAs of the block 302 (which in this example consists of group 204); and the region of VA+12 through VA+15 is not included in the contiguous IPAs of the block 302. Although not shown for purposes of clarity, hardware logic may be employed to identify the contiguous IPA groups and compute each tag, including the size parameter and location information, using the IPAs corresponding to VA_0 through VA+15 as inputs.

The tag may be stored in the TLB in any manner. For example, the tag may be stored in the form of higher-order bits above the PA page bits (i.e., “PA_W”). Generally, a 4-bit linearity tag space may be added in TLB cache. As the TLB storage is implemented in SRAM, area overhead is usually minimal. Linearity tags greater than 4-bits are possible. As understood by one of ordinary skill in the art, the size of the linearity tag depends upon the maximum page size supported (i.e. 4-bit linearity tags are used in the present examples because a maximum page size is described as 64 KB). As noted here and below, maximum page sizes beyond 64 kB are possible and thus, larger linearity tags beyond 4-bits may be employed for such larger page sizes.

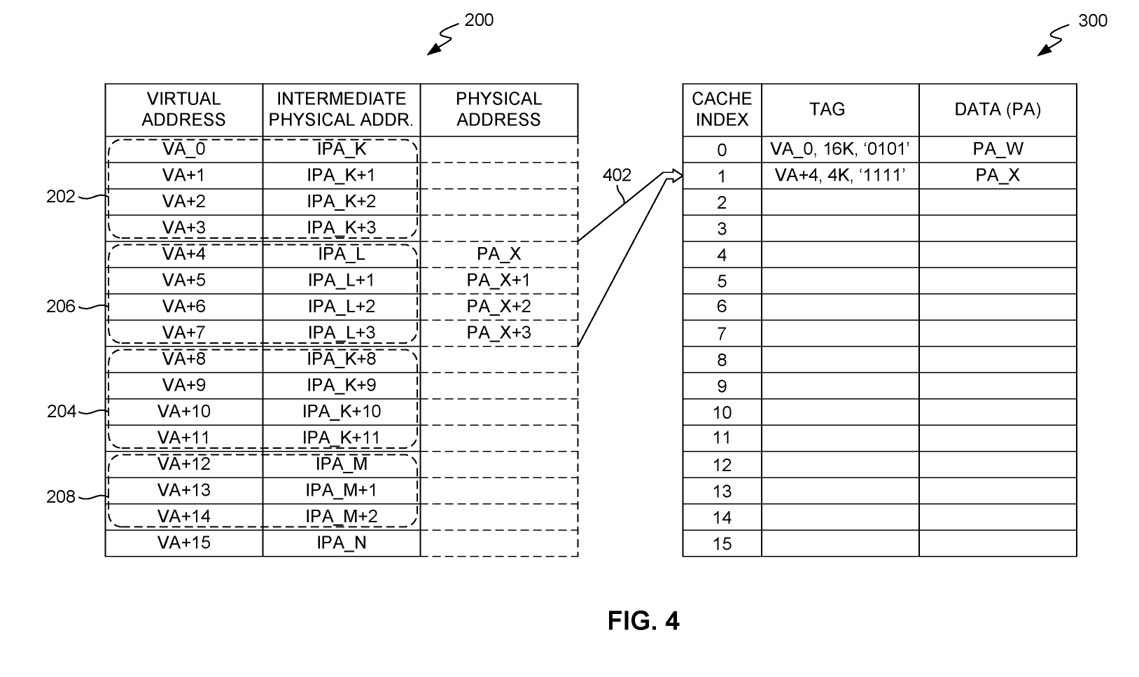

Continuing the example with reference to FIG. 4, the MMU may determine and store information identifying the PAs corresponding to the third group 206 in a manner similar to that described above with regard to the first and second groups 202 and 204. However, as the third group 206 does not represent a continuation of a linear address space of another group, the MMU cannot combine the information identifying the PAs corresponding to the third group 206 with the information identifying the PAs corresponding to another group in the manner described above with regard to the first and second groups 202 and 204. Thus, the MMU may determine that the base PA corresponding to the third group 206 is PA_X, and store PA_X along with an associated tag in a second entry (e.g., cache index “1”) in the data structure 300 in its TLB.

The tag includes the base VA of the third group 206, a size parameter indicating the size of a burst-readable block 402 of IPAs that encompasses the third group 206, and location information identifying locations of the contiguous IPAs within that block. In the illustrated example, a size parameter of 4 kB indicates that the one or more contiguous IPAs can be found within a compressed 16 kB region (i.e., compressed to 4 kB) beginning at the base VA of the third group 206, VA+4. That is, in the example illustrated in FIG. 4 a 16 kB region is represented using only 4 kB of address space. Note in FIG. 4 that a 16 kB region beginning at the base VA of the third group 206 begins at VA+4 and ends at VA+7.

The location information indicates the locations of the contiguous IPAs within the block 402. In the example illustrated in FIG. 4, a bit value of ‘1’ in a bit position of the 4-bit location information may indicate that the 4 kB region corresponding to that bit position is included in the contiguous IPAs of the block 402, while a bit value of ‘0’ in a bit position of the 4-bit location information may indicate that the 4 kB region corresponding to that bit position is not included in the contiguous IPAs of the block 402. More specifically, the least-significant bit or zero-th position bit may correspond to the 4B region at VA+4, the next-most significant or first-position bit may correspond to the 4 kB region at VA+5, the second-position bit may correspond to the 4 kB region at VA+6, and the most-significant bit or third-position bit may correspond to the 4 kB region at VA+7. Accordingly, in the example illustrated in FIG. 4 the location information of ‘1111’ indicates that each 4 kB region, i.e., each of VA+4, VA+5, VA+6, and VA+7, is included in the contiguous IPAs of the block 402.

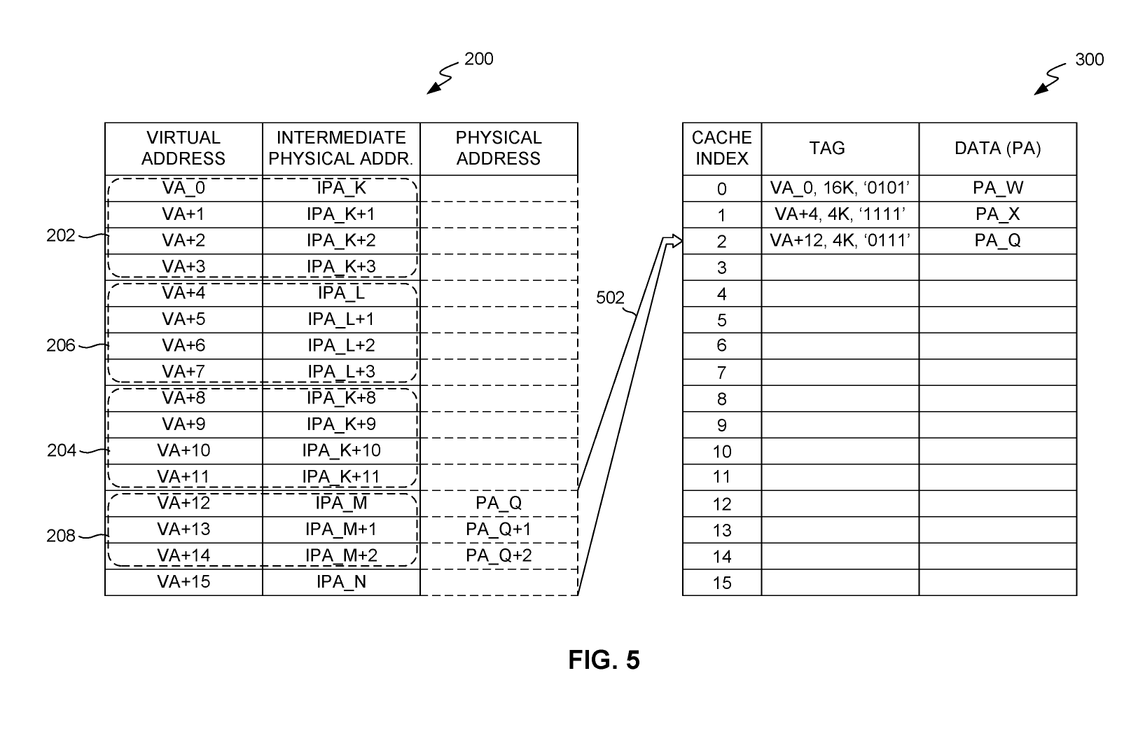

Continuing the example with reference to FIG. 5, the MMU may determine and store information identifying the PAs corresponding to the fourth group 208. Like the third group 206, the fourth group 208 does not represent a continuation of a linear address space of another group. Therefore, the MMU cannot combine the information identifying the PAs corresponding to the fourth group 208 with the information identifying the PAs corresponding to another group. Accordingly, the MMU may determine that the base PA corresponding to the fourth group 208 is PA_Q, and store PA_Q along with an associated tag in a third entry (e.g., cache index “2”) in the data structure 300 in its TLB.

The tag includes the base VA of the fourth group 208, a size parameter indicating the size of a burst-readable block 502 of IPAs that encompasses the fourth group 208, and location information identifying locations of the contiguous IPAs within that block. In the illustrated example, a size parameter of 4 kB indicates that the one or more contiguous IPAs can be found within a compressed 16 kB region (i.e., compressed to 4 kB) beginning at the base VA of the fourth group 206, VA+12. Note in FIG. 5 that a 16 kB region beginning at the base VA of the fourth group 208 begins at VA+12 and ends at VA+15.

The location information indicates the locations of the contiguous IPAs within the block 502. In the example illustrated in FIG. 5, a bit value of ‘1’ in a bit position of the 4-bit location information may indicate that the 4 kB region corresponding to that bit position is included in the contiguous IPAs of the block 502, while a bit value of ‘0’ in a bit position of the 4-bit location information may indicate that the 4 kB region corresponding to that bit position is not one included in the contiguous IPAs of the block 502. More specifically, the least-significant bit or zero-th position bit may correspond to the 4B region at VA+12, the next-most significant or first-position bit may correspond to the 4 kB region at VA+13, the second-position bit may correspond to the 4 kB region at VA+14, and the most-significant bit or third-position bit may correspond to the 4 kB region at VA+15. Accordingly, in the example illustrated in FIG. 5 the location information of ‘0111’ indicates that VA+12, VA+13, and VA+14, are included in the contiguous IPAs of the block 502, but VA+15 is not included in the contiguous IPAs of the block 502.

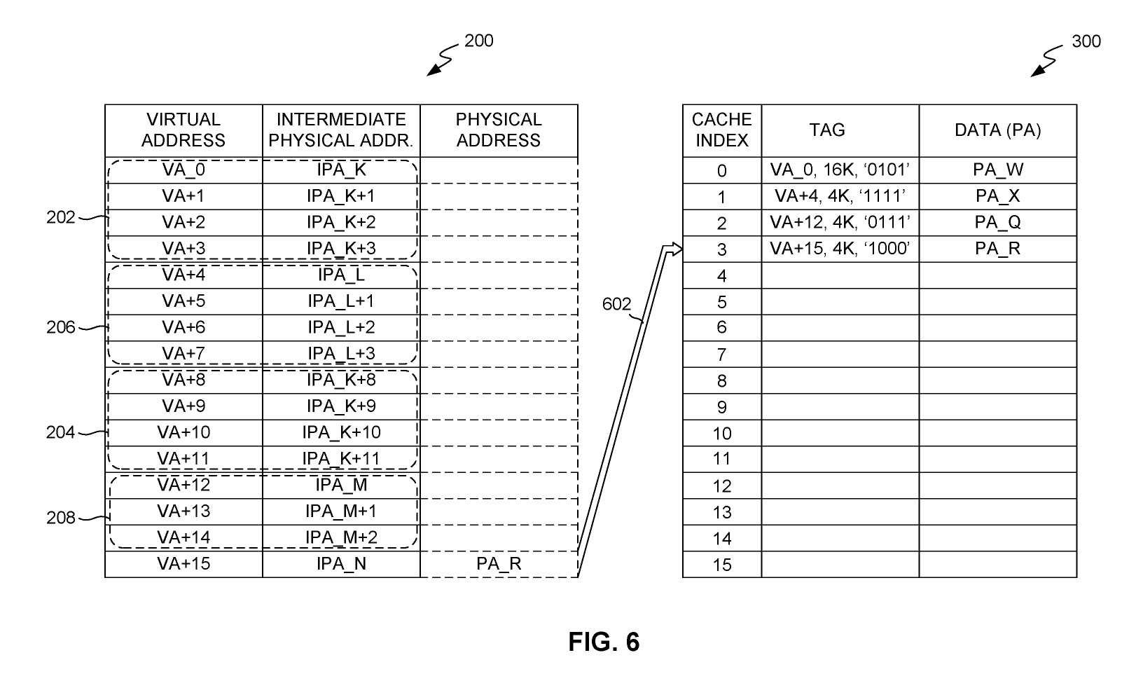

Continuing the example with reference to FIG. 6, the MMU may determine and store information identifying the PA corresponding to IPA_N, which as noted above is not part of any group defined by a plurality of contiguous IPAs. Thus, the MMU may determine that the PA corresponding to IPA_N is PA_R, and store PA_R along with an associated tag in a fourth entry (e.g., cache index “3”) in the data structure 300 in its TLB.

The tag includes the VA corresponding to IPA_N, a size parameter indicating the size of a read 602 that encompasses IPA_N, and location information identifying locations of the one or more contiguous IPAs within the data that is read. In the illustrated example, a size parameter of 4 kB indicates that the one or more contiguous IPAs can be found within a 4 kB region of the data that is read.

The location information indicates the locations of the one or more contiguous IPAs within the read 602. In the example illustrated in FIG. 6, a bit value of ‘1’ in a bit position of the 4-bit location information may indicate that the 4 kB region corresponding to that bit position is included in the one or more contiguous IPAs of the read 602, while a bit value of ‘0’ in a bit position of the 4-bit location information may indicate that the 4 kB region corresponding to that bit position is not included in the one or more contiguous IPAs of the read 602. More specifically, the least-significant bit or zero-th position bit may correspond to the 4 kB region at VA+12, the next-most significant or first-position bit may correspond to the 4 kB region at VA+13, the second-position bit may correspond to the 4 kB region at VA+14, and the most-significant bit or third-position bit may correspond to the 4 kB region at VA+15.

Based on this, it is intended that the same tag is extended based on the decoding scheme to cover most or all scenarios. In this case, a 4-bit value 1000 and a size 4 k means only one 4 KB page is stored corresponding to VA+15. This is equivalent to storing single 4 KB page mapping in a single TLB entry as done in conventional systems without any 4-bit tag.

Accordingly, in the example illustrated in FIG. 6 the location information of ‘1000’ indicates that VA+12, VA+13, and VA+14 are not included in the contiguous IPAs of read 602, leaving VA+15 as the remaining IPA in the read 602.

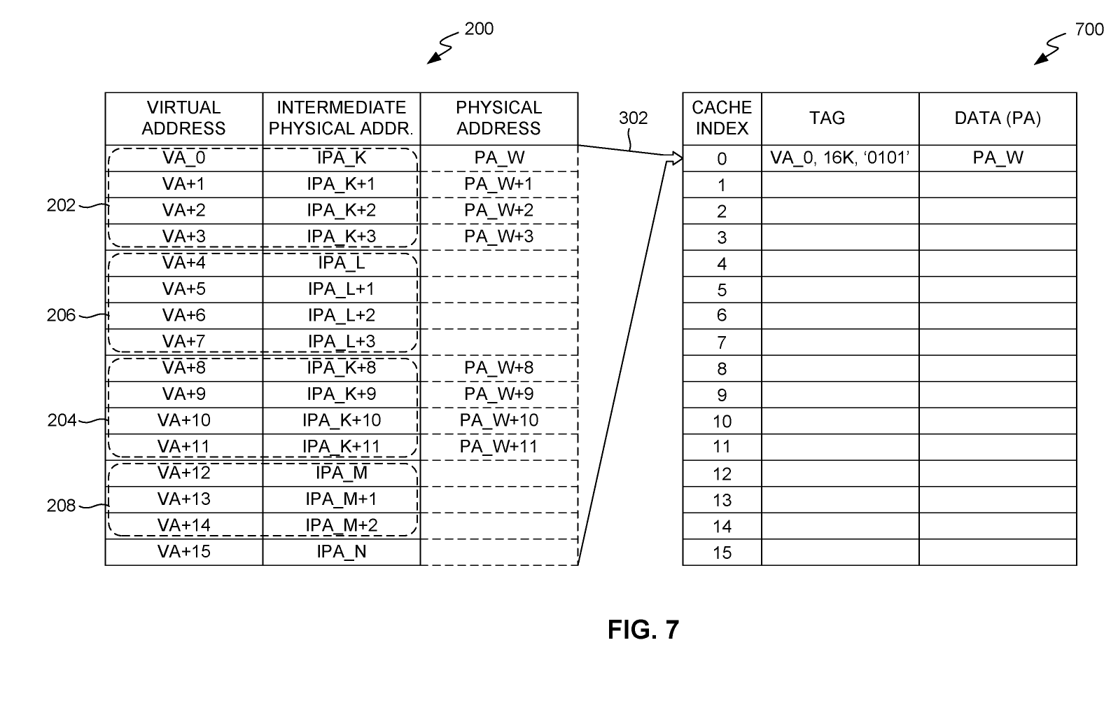

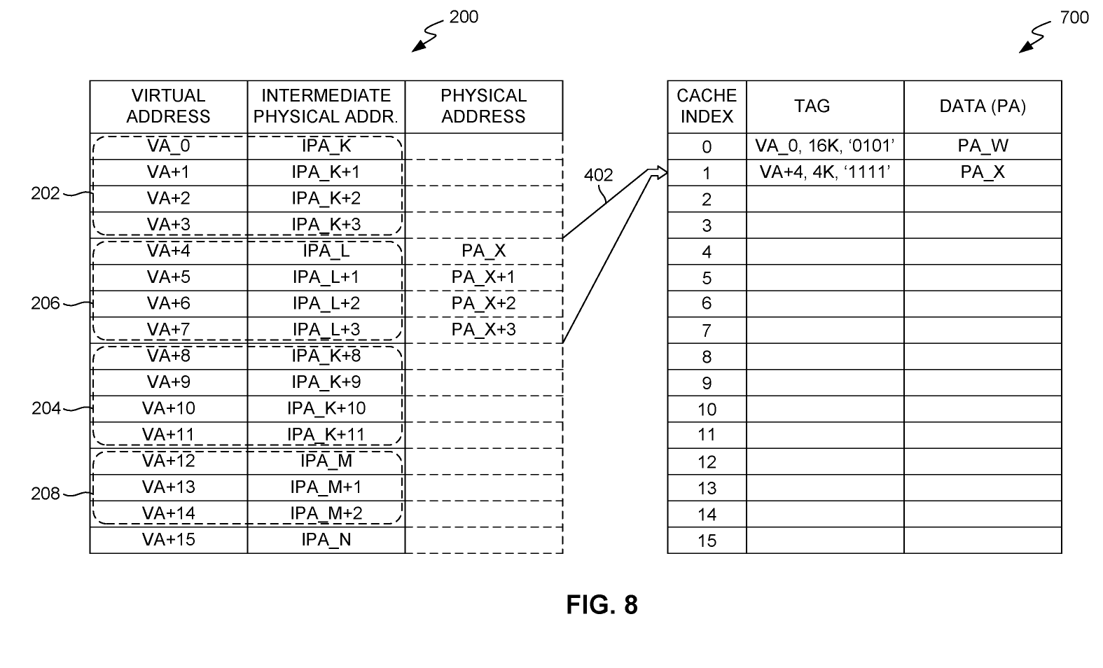

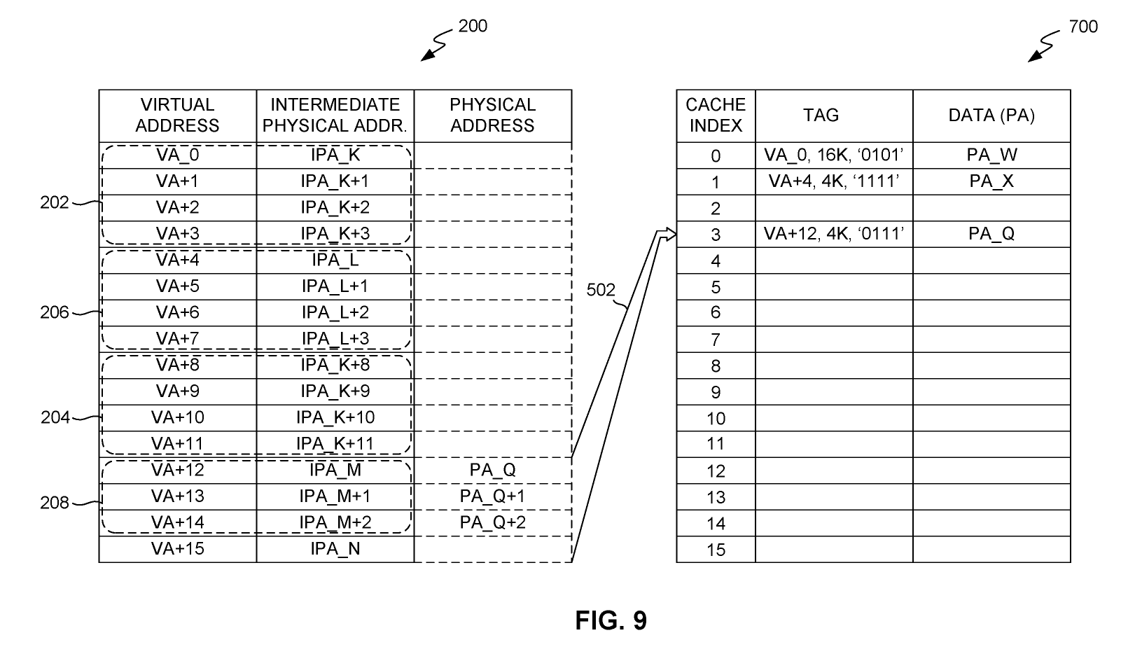

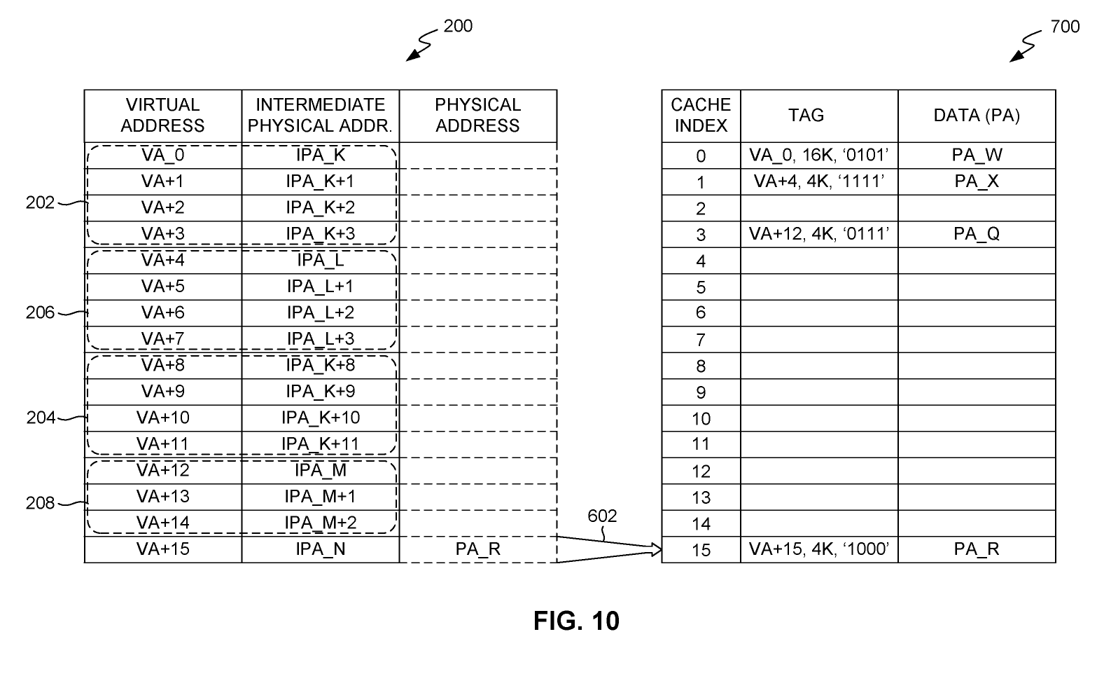

Another example, illustrated in FIGS. 7-10, is similar to the example illustrated in FIGS. 3-6, except that whereas the data structure 300 in FIGS. 3-6 represents fully associative caching in the TLB, the data structure 700 in FIGS. 7-10 represents way-based caching in the TLB. But for this difference, FIG. 7 is similar to above-described FIG. 3; FIG. 8 is similar to above-described FIG. 4; FIG. 9 is similar to above-described FIG. 5; and FIG. 10 is similar to above-described FIG. 6. Accordingly, FIGS. 7-10 are not described in similar detail.

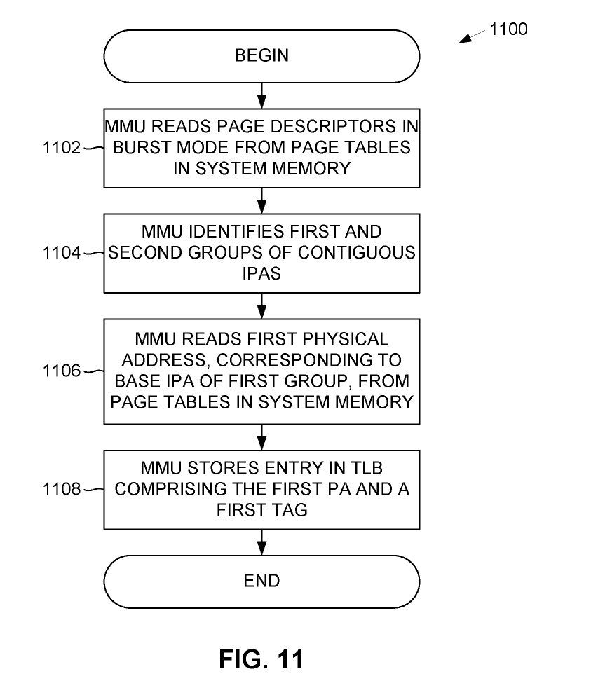

As illustrated in FIG. 11, an exemplary method for storing an address translation in a memory system may be controlled by an MMU. An MMU (or a processor thereof) may be programmed or otherwise configured to control the method, and the configured MMU or processor may serve as means for performing a corresponding step of the method. The method may be performed when, for example, a memory transaction results in a TLB miss. The MMU may employ a two-stage table walk to add PAs to the TLB that the TLB miss indicated were not already stored (i.e., cached) in the TLB.

As indicated by block 1102, the MMU may read two or more page descriptors in a burst mode from one or more page tables in a system memory. Such a burst-mode read characterizes the first stage of the two-stage table walk. In the examples described above, the MMU reads 16 such page descriptors, each comprising a VA and a corresponding IPA. The MMU may then use the IPAs to determine the PAs in the second stage of the two-stage table walk.

Generally, the MMU may read any one or more of the IPAs to determine a corresponding PA. In some instances, the MMU may, for example, read each IPA individually (i.e., a single read operation) to determine a corresponding PA. However, as indicated by block 1104, in at least some instances the MMU may identify a first group of two or more contiguous IPAs beginning at a first base IPA, and a second group of two or more contiguous IPAs beginning at an offset from the first base IPA. The first and second groups of contiguous IPAs may be separated from the second group of contiguous IPAs by at least one IPA that is not contiguous with the first group or second group. Nevertheless, the MMU may read the first and second groups together in a single burst-mode or block read.

As indicated by block 1106, the MMU may use the base IPA of the first and second groups of contiguous IPAs to read a corresponding first base PA from the one or more page tables in the system memory. The MMU need not read all of the PAs corresponding to all of the IPAs of the first and second groups because those remaining PAs may be computed from the first base PA.

As indicated by block 1108, the MMU may store a first entry in its TLB that includes the above-referenced first base PA and a tag. The tag may include the VA corresponding to the first base PA as well as a size parameter and location information. The size parameter may indicate the size of a burst-readable block of IPAs that encompasses the first and second groups. The location information may identify locations of the contiguous IPAs (defining the first and second groups) within that block.

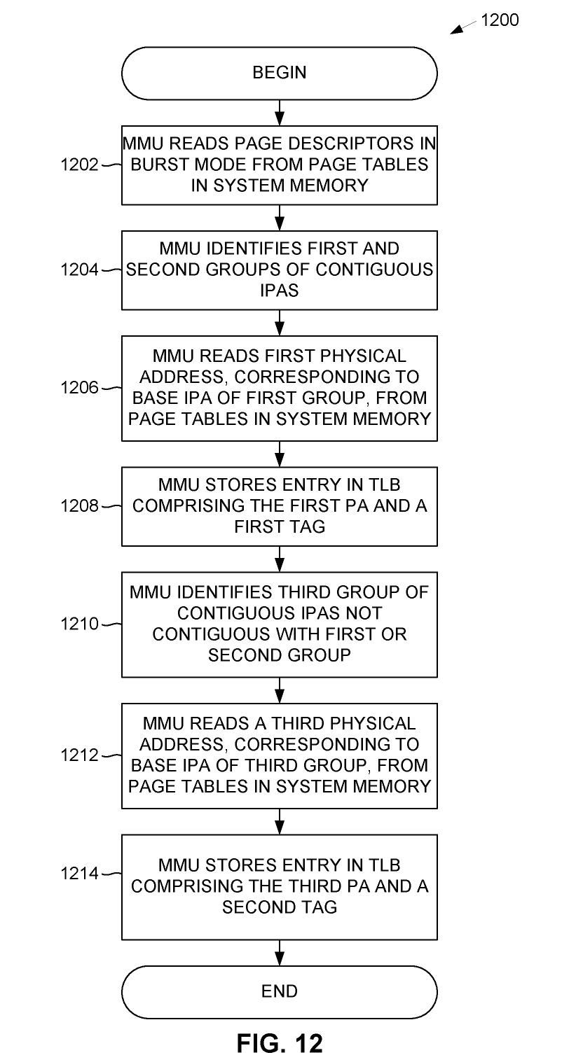

Another exemplary method, illustrated in FIG. 12, is similar to the exemplary method illustrated in FIG. 11 but further includes storing a second entry in the TLB. Thus, blocks 1202, 1204, 1206, and 1208 are identical to above-described blocks 1102, 1104, 1106, and 1108. Blocks 1210, 1212, and 1214 relate to determining and storing the second entry in the TLB.

As indicated by block 1210, the MMU may identify a third group of contiguous IPAs that is not contiguous with either of the first or second groups. The base IPA of the third group of contiguous IPAs may be referred to as a second base IPA. As indicated by block 1212, the MMU may use the second base IPA to read a corresponding second base PA from the one or more page tables in the system memory. As indicated by block 1214, the MMU may store a second entry in its TLB that includes the second base PA and a second tag. The second tag may include the VA corresponding to the second base PA as well as a size parameter and location information.

Although not shown in FIGS. 11 and 12 for purposes of clarity, the MMU may read any non-contiguous IPAs individually, i.e., not in burst mode, to determine a corresponding PA.

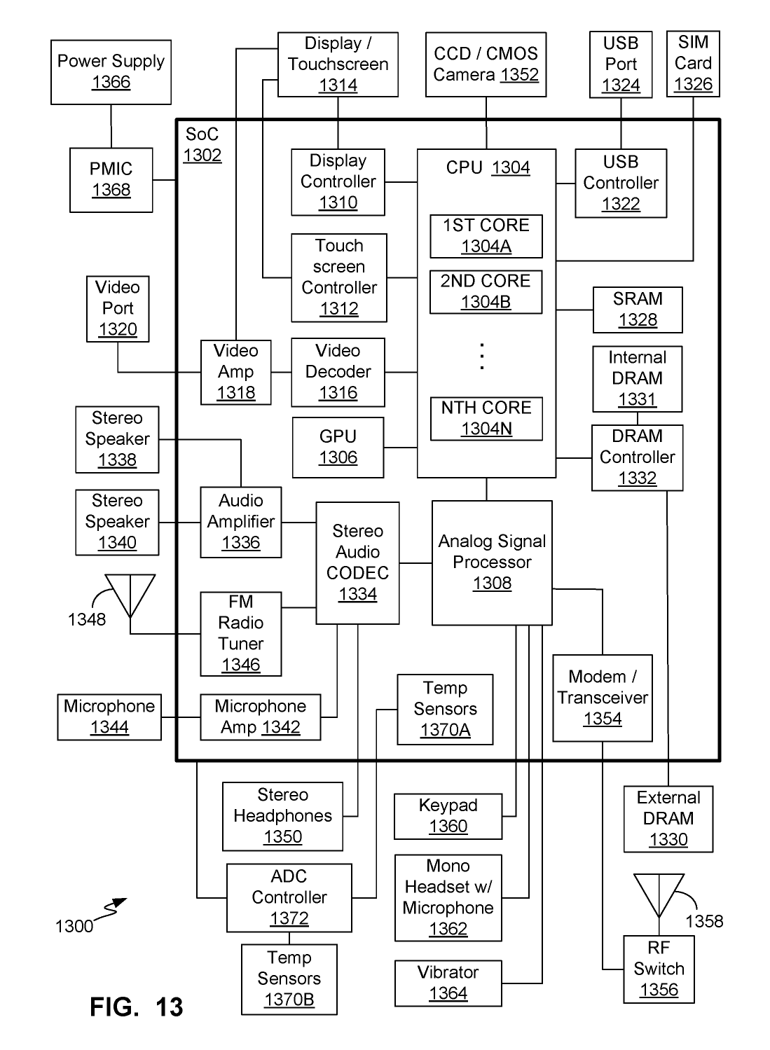

As illustrated in FIG. 13, illustrative or exemplary embodiments, systems, methods, and computer program products for storing an address translation in a memory system may be embodied in a PCD 1300. The PCD 1300 includes a system on chip (“SoC”) 1302, i.e., a system embodied in an integrated circuit chip. The SoC 1302 may include a central processing unit (“CPU”) 1304, a graphics processing unit (“GPU”) 1306, or other processors. The CPU 1304 may include multiple cores, such as a first core 1304A, a second core 1304B, etc., through an Nth core 1304N. The SoC 1302 may include an analog signal processor 1308. The CPU 1304 may be an example of the CPU cluster 104 described above with regard to FIG. 1. The GPU 1306 may be an example of the GPU subsystem 106 described above with regard to FIG. 1.

A display controller 1310 and a touchscreen controller 1312 may be coupled to the CPU 1304. A touchscreen display 1314 external to the SoC 1302 may be coupled to the display controller 1310 and the touchscreen controller 1312. The display controller 1310 and touchscreen controller 1312 may together be an example of the multimedia subsystem 108 described above with regard to FIG. 1. The PCD 1300 may further include a video decoder 1316. The video decoder 1316 is coupled to the CPU 1304. A video amplifier 1318 may be coupled to the video decoder 1316 and the touchscreen display 1314. A video port 1320 may be coupled to the video amplifier 1318. A universal serial bus (“USB”) controller 1322 may also be coupled to CPU 1304, and a USB port 1324 may be coupled to the USB controller 1322. A subscriber identity module (“SIM”) card 1326 may also be coupled to the CPU 1304.

One or more memories may be coupled to the CPU 1304. The one or more memories may include both volatile and non-volatile memories. Examples of volatile memories include static random access memory (“SRAM”) 1328 and dynamic RAMs (“DRAM”s) 1330 and 1331. Such memories may be external to the SoC 1302, such as the DRAM 1330, or internal to the SoC 1302, such as the DRAM 1331. One or both of the DRAMs 1330 and 1331 may be an example of the system memory 102 described above with regard to FIG. 1. A DRAM controller 1332 coupled to the CPU 1304 may control the writing of data to, and reading of data from, the DRAMs 1330 and 1331. In other embodiments, such a DRAM controller may be included within a processor, such as the CPU 1304.

A stereo audio CODEC 1334 may be coupled to the analog signal processor 1308. Further, an audio amplifier 1336 may be coupled to the stereo audio CODEC 1334. First and second stereo speakers 1338 and 1340, respectively, may be coupled to the audio amplifier 1336. In addition, a microphone amplifier 1342 may be coupled to the stereo audio CODEC 1334, and a microphone 1344 may be coupled to the microphone amplifier 1342. A frequency modulation (“FM”) radio tuner 1346 may be coupled to the stereo audio CODEC 1334. An FM antenna 1348 may be coupled to the FM radio tuner 1346. Further, stereo headphones 1350 may be coupled to the stereo audio CODEC 1334. Other devices that may be coupled to the CPU 1304 include a digital (e.g., CCD or CMOS) camera 1352.

A modem or radio frequency (“RF”) transceiver 1354 may be coupled to the analog signal processor 1308. An RF switch 1356 may be coupled to the RF transceiver 1354 and an RF antenna 1358. In addition, a keypad 1360, a mono headset with a microphone 1362, and a vibrator device 1364 may be coupled to the analog signal processor 1308.

A power supply 1366 may be coupled to the SoC 1302 via a power management integrated circuit (“PMIC”) 1368. The power supply 1366 may include a rechargeable battery or a DC power supply that is derived from an AC-to-DC transformer connected to an AC power source.

The SoC 1302 may have one or more internal or on-chip thermal sensors 1370A and may be coupled to one or more external or off-chip thermal sensors 1370B. The one or more of on-chip thermal sensors 1370A may be examples of junction thermal sensor 122 (FIG. 1). An analog-to-digital converter (“ADC”) controller 1372 may convert voltage drops produced by the thermal sensors 1370A and 1370B to digital signals.

The touch screen display 1314, the video port 1320, the USB port 1324, the camera 1352, the first stereo speaker 1338, the second stereo speaker 1340, the microphone 1344, the FM antenna 1348, the stereo headphones 1350, the RF switch 1356, the RF antenna 1358, the keypad 1360, the mono headset 1362, the vibrator 1364, the thermal sensors 1370B, the ADC controller 1372, the PMIC 1368, the power supply 1366, the DRAM 1330, and the SIM card 1326 are external to the SoC 1302 in this exemplary or illustrative embodiment. It will be understood, however, that in other embodiments one or more of these devices may be included in such an SoC.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for storing an address translation in a memory system, comprising:
reading, by a memory management unit (“MMU”) in a burst mode, a plurality of page descriptors from one or more page tables in a system memory, the plurality of page descriptors comprising a plurality of virtual addresses (“VAs”) and a plurality of intermediate physical address (“IPAs”), each of the IPAs uniquely corresponding to one of the VAs;
identifying in the plurality of page descriptors, by the MMU, a first plurality of contiguous IPAs beginning at a first base IPA and a second plurality of contiguous IPAs beginning at an offset from the first base IPA, the first plurality of contiguous IPAs separated from the second plurality of contiguous IPAs by at least one IPA not contiguous with the first plurality of contiguous IPAs or the second plurality of contiguous IPAs;
reading, by the MMU, a first physical address (“PA”) from the one or more page tables in the system memory, the first PA corresponding to the first base IPA; and
storing, by the MMU, an entry in a translation lookaside buffer (“TLB”) comprising the first PA and a first linearity tag.

2. The method of claim 1, wherein the first linearity tag comprises a VA corresponding to the first base IPA and block information identifying a size of a burst-readable block of IPAs including the first plurality of contiguous IPAs and the second plurality of contiguous IPAs.

3. The method of claim 2, wherein the first linearity tag further comprises location information identifying locations of the first plurality of contiguous IPAs and the second plurality of contiguous IPAs within the block of IPAs.

4. The method of claim 3, wherein the location information comprises a plurality of bits, each bit associated with a group of one or more IPAs of the block of IPAs and identifying whether the group consists of contiguous IPAs.

5. The method of claim 1, wherein the at least one IPA not contiguous with the first plurality of contiguous IPAs or the second plurality of contiguous IPAs comprises a third plurality of contiguous IPAs beginning at a second base IPA, the method further comprising:
reading, by the MMU, a second PA from the one or more page tables in the system memory, the second PA corresponding to the second base IPA; and
storing, by the MMU, a second entry in the TLB comprising the second PA and a second linearity tag.

6. The method of claim 1, wherein the tag is included in higher-order bits of the entry in the TLB comprising the first PA and the first linearity tag.

7. The method of claim 1, wherein the system memory and the MMU are included in a portable computing device (“PCD”).

8. The method of claim 7, wherein the PCD comprises at least one of a mobile telephone, a personal digital assistant, a pager, a smartphone, a navigation device, and a hand-held computer with a wireless connection or link.

9. A system for storing an address translation, comprising:
a system memory configured to store one or more page tables;
a memory management unit (“MMU”) having an MMU memory, the MMU configured to:
read a plurality of page descriptors in a burst mode from the one or more of the page tables in the system memory, the plurality of page descriptors comprising a plurality of virtual addresses (“VAs”) and a plurality of intermediate physical address (“IPAs”), each of the IPAs uniquely corresponding to one of the VAs;
identify in the plurality of page descriptors a first plurality of contiguous IPAs beginning at a first base IPA and a second plurality of contiguous IPAs beginning at an offset from the first base IPA, the first plurality of contiguous IPAs separated from the second plurality of contiguous IPAs by at least one IPA not contiguous with the first plurality of contiguous IPAs or the second plurality of contiguous IPAs;
read a first physical address (“PA”) from the one or more page tables in the system memory, the first PA corresponding to the first base IPA; and
store an entry in a translation lookaside buffer (“TLB”) in the MMU memory comprising the first PA and a first linearity tag.

10. The system of claim 9, wherein the first linearity tag comprises a VA corresponding to the first base IPA and block information identifying a size of a burst-readable block of IPAs including the first plurality of contiguous IPAs and the second plurality of contiguous IPAs.

11. The system of claim 10, wherein the first linearity tag further comprises location information identifying locations of the first plurality of contiguous IPAs and the second plurality of contiguous IPAs within the block of IPAs.

12. The system of claim 11, wherein the location information comprises a plurality of bits, each bit associated with a group of one or more IPAs of the block of IPAs and identifying whether the group consists of contiguous IPAs.

13. The system of claim 9, wherein the at least one IPA not contiguous with the first plurality of contiguous IPAs or the second plurality of contiguous IPAs comprises a third plurality of contiguous IPAs beginning at a second base IPA, the MMU further configured to:
read a second PA from the one or more page tables in the system memory, the second PA corresponding to the second base IPA; and
store a second entry in the TLB comprising the second PA and a second tag.

14. The system of claim 9, wherein the first linearity tag is included in higher-order bits of the entry in the TLB comprising the first PA and the first linearity tag.

15. The system of claim 9, wherein the system memory and the MMU are included in a portable computing device (“PCD”).

16. The system of claim 15, wherein the PCD comprises at least one of a mobile telephone, a personal digital assistant, a pager, a smartphone, a navigation device, and a hand-held computer with a wireless connection or link.

17. A system for storing an address translation in a memory system, comprising:
means for reading a plurality of page descriptors in a burst mode from one or more page tables in a system memory, the plurality of page descriptors comprising a plurality of virtual addresses (“VAs”) and a plurality of intermediate physical address (“IPAs”), each of the IPAs uniquely corresponding to one of the VAs;
means for identifying in the plurality of page descriptors a first plurality of contiguous IPAs beginning at a first base IPA and a second plurality of contiguous IPAs beginning at an offset from the first base IPA, the first plurality of contiguous IPAs separated from the second plurality of contiguous IPAs by at least one IPA not contiguous with the first plurality of contiguous IPAs or the second plurality of contiguous IPAs;
means for reading a first physical address (“PA”) from the one or more page tables in the system memory, the first PA corresponding to the first base IPA; and
means for storing an entry in a translation lookaside buffer (“TLB”) comprising the first PA and a first linearity tag.

18. The system of claim 17, wherein the first linearity tag comprises a VA corresponding to the first base IPA and block information identifying a size of a burst-readable block of IPAs including the first plurality of contiguous IPAs and the second plurality of contiguous IPAs.

19. The system of claim 18, wherein the first linearity tag further comprises location information identifying locations of the first plurality of contiguous IPAs and the second plurality of contiguous IPAs within the block of IPAs.

20. The system of claim 19, wherein the location information comprises a plurality of bits, each bit associated with a group of one or more IPAs of the block of IPAs and identifying whether the group consists of contiguous IPAs.

21. The system of claim 17, wherein the at least one IPA not contiguous with the first plurality of contiguous IPAs or the second plurality of contiguous IPAs comprises a third plurality of contiguous IPAs beginning at a second base IPA, the system further comprising:
means for reading a second PA from the one or more page tables in the system memory, the second PA corresponding to the second base IPA; and
means for storing a second entry in the TLB comprising the second PA and a second linearity tag.

22. The system of claim 17, wherein the first linearity tag is included in higher-order bits of the entry in the TLB comprising the first PA and the first linearity tag.

23. The system of claim 17, wherein the system memory and the MMU are included in a portable computing device (“PCD”).

24. The system of claim 23, wherein the PCD comprises at least one of a mobile telephone, a personal digital assistant, a pager, a smartphone, a navigation device, and a hand-held computer with a wireless connection or link.

25. A computer program product comprising a computer-readable medium having stored thereon in executable form instructions that when executed by a memory management processor configure the memory management processor to:
read a plurality of page descriptors in a burst mode from one or more page tables in a system memory, the plurality of page descriptors comprising a plurality of virtual addresses (“VAs”) and a plurality of intermediate physical address (“IPAs”), each of the IPAs uniquely corresponding to one of the VAs;
identify in the plurality of page descriptors a first plurality of contiguous IPAs beginning at a first base IPA and a second plurality of contiguous IPAs beginning at an offset from the first base IPA, the first plurality of contiguous IPAs separated from the second plurality of contiguous IPAs by at least one IPA not contiguous with the first plurality of contiguous IPAs or the second plurality of contiguous IPAs;
read a first physical address (“PA”) from the one or more page tables in the system memory, the first PA corresponding to the first base IPA; and
store an entry in a translation lookaside buffer (“TLB”) comprising the first PA and a first linearity tag.

26. The computer program product of claim 25, wherein the first linearity tag comprises a VA corresponding to the first base IPA and block information identifying a size of a burst-readable block of IPAs including the first plurality of contiguous IPAs and the second plurality of contiguous IPAs.

27. The computer program product of claim 26, wherein the first linearity tag further comprises location information identifying locations of the first plurality of contiguous IPAs and the second plurality of contiguous IPAs within the block of IPAs.

28. The computer program product of claim 27, wherein the location information comprises a plurality of bits, each bit associated with a group of one or more IPAs of the block of IPAs and identifying whether the group consists of contiguous IPAs.

29. The computer program product of claim 25, wherein the at least one IPA not contiguous with the first plurality of contiguous IPAs or the second plurality of contiguous IPAs comprises a third plurality of contiguous IPAs beginning at a second base IPA, the instructions further configuring the memory management processor to:
read a second PA from the one or more page tables in the system memory, the second PA corresponding to the second base IPA; and
store a second entry in the TLB comprising the second PA and a second tag.

30. The computer program product of claim 25, wherein the first linearity tag is included in higher-order bits of the entry in the TLB comprising the first PA and the first linearity tag.
